(19) United States
(12) Patent Application Publication
(10) Pub. No.: US 2016/0225078 A1
(43) Pub. Date: Aug. 4, 2016

(54) WEB BASED COMMERCIAL LOAN PLATFORM

(71) Applicant: CommLoan.com LLC, Scottsdale, AZ (US)

(72) Inventors: Mitchell Ginsberg, Scottsdale, AZ (US); Marc M. Mirbod, San Diego, CA (US)

(21) Appl. No.: 15/013,582

(22) Filed: Feb. 2, 2016

Related U.S. Application Data
(60) Provisional application No. 62/110,758, filed on Feb. 2, 2015.

(51) Int. Cl. G06Q 40/02

(52) U.S. Cl. CPC G06Q 40/025

(57) ABSTRACT

A commercial loan platform is disclosed which provides access to relatively small commercial loan originators to literally hundreds of lenders and loan programs. In order to enable the small commercial loan originators to better service their clients, the commercial loan platform can be configured as a private label website. The commercial loan platform includes a matching engine which matches the commercial loan request originated by the small commercial loan originator with the loan program and lender that best fits the parameters of the request. By comparing the borrower's needs with a multitude of various loan programs, the borrower will not only get the most competitive loan but the loan that best fits their needs. Processing of the commercial loan is handled by a central processing center which enables such small commercial loan originators to handle the commercial loans in a cost efficient manner. By having access to hundreds of lending sources, smaller commercial loan originators will be able to better serve clients, which previously would not have been cost effective

### CROSS REFERENCE TO RELATED APPLICATIONS

This application claims priority to and claims the benefit of U.S. Provisional Patent Application No. 62/110,758, filed on Feb. 2, 2015, hereby incorporated by reference.

### BACKGROUND OF THE INVENTION

1. Field of the Invention

The present invention relates to a web based commercial loan platform for connecting relatively small commercial loan originators with hundreds of commercial lenders while providing commercial loan processing services and optionally provide such services to such small commercial loan originators on a private label basis.

2. Description of the Prior Art

A commercial loan is normally a relatively short term loan to a business. Commercial loans are used by businesses for various purposes. For example, commercial loans are normally used for capital expenditures for equipment, inventory and machinery as well as real estate. Commercial loans are also used to provide working capital for a company.

Processing commercial loans is significantly more complicated than processing personal loans. For example, if the capital is for a new or existing business, a business plan may be required with projected earnings and profits. Relatively small commercial loan originators, such as commercial loan brokers, normally are unable to process commercial loans due in part to their lack of expertise in evaluating such documentation and do not have a sufficient volume of commercial loans to justify developing the expertise.

Unfortunately, due the lack of standardization of commercial loan programs and guidelines, commercial loan brokers normally only have limited access to a few commercial lenders with which relationships have been developed. Since large national banks, insurance companies and smaller regional banks are known to dominate the commercial real estate industry, the problem of limited access not only affects these brokers, it also affects commercial real estate companies and residential mortgage companies. Thus, there is a need to provide relatively small commercial loan originators with better access to commercial lenders.

### SUMMARY OF THE INVENTION

Briefly, the present invention relates to a commercial loan platform which provides access to relatively small commercial loan originators to literally hundreds of lenders and loan programs. In order to enable small commercial loan originators to better service their clients, the commercial loan platform may be configured as a private label website. The commercial loan platform includes a matching engine used for pre-qualification of the loan which matches the borrower's commercial loan request data originated by the small commercial loan originator with the loan program and lender that best fits the parameters of the request. By comparing the borrower's needs with a multitude of various loan programs, the borrower will not only get the most competitive loan but the loan that best fits their needs. Processing of the commercial loan may be handled by a central processing center which enables such small commercial loan originators to handle the commercial loans in a cost efficient manner. By having access to hundreds of lending sources, smaller commercial loan originators will be able to better serve clients, which previously would not have been cost effective.

### DESCRIPTION OF THE DRAWING

These and other advantages of the present invention will be readily understood with reference to the following specification and attached drawing wherein:

FIG. 1 is a block diagram of the commercial loan platform in accordance with the present invention.

FIG. 2 is an exemplary diagram illustrating the connections between the commercial lenders, the small commercial originators and the commercial loan platform in accordance with the present invention.

FIG. 3 illustrates the exemplary commercial lending criteria and logic.

FIG. 4A is an exemplary flow diagram of one embodiment of the matching engine which illustrates the various fields on the loan application which are used to compare with the exemplary lender criteria illustrated in FIG. 3 in which each data point of interest from the borrower's loan application is compared with a corresponding lender loan criteria before the next data point is parsed.

FIG. 4B illustrates an alternate embodiment of the matching engine logic of gathering the data from the borrower's loan application and comparing it with the lender criteria illustrated in FIG. 3 in which all data points from the borrower's loan applications are parsed before any comparisons are made.

FIG. 5 is an exemplary diagram illustrating access to the commercial loan platform by various members.

FIG. 6 is an exemplary logic diagram illustrating new client registration.

FIG. 7 is an exemplary logic diagram illustrating a borrower's access to the commercial loan platform.

FIG. 8 is an exemplary logic diagram illustrating the borrower's submission process.

FIG. 9 illustrates an example of the underwriting metrics in which two properties 1 and 2 are refinanced for rehabilitation.

### DETAILED DESCRIPTION

The invention relates to a commercial loan platform which provides access to relatively small commercial loan originators to literally hundreds of lenders and loan programs. In order to enable the small commercial loan originators to better service their clients, the commercial loan platform can be configured as a private label website. The commercial loan platform includes a matching engine which matches the commercial loan request originated by the small commercial loan originator with the loan program and lender that best fits the parameters of the request. By comparing the borrower's needs with a multitude of various loan programs, the borrower will not only get the most competitive loan but the loan that best fits their needs. Processing of the commercial loan is handled by a central processing center which enables such small commercial loan originators to handle the commercial loans in a cost efficient manner. By having access to hundreds of lending sources, smaller commercial loan originators will be able to better serve clients, which previously would not have been cost effective.

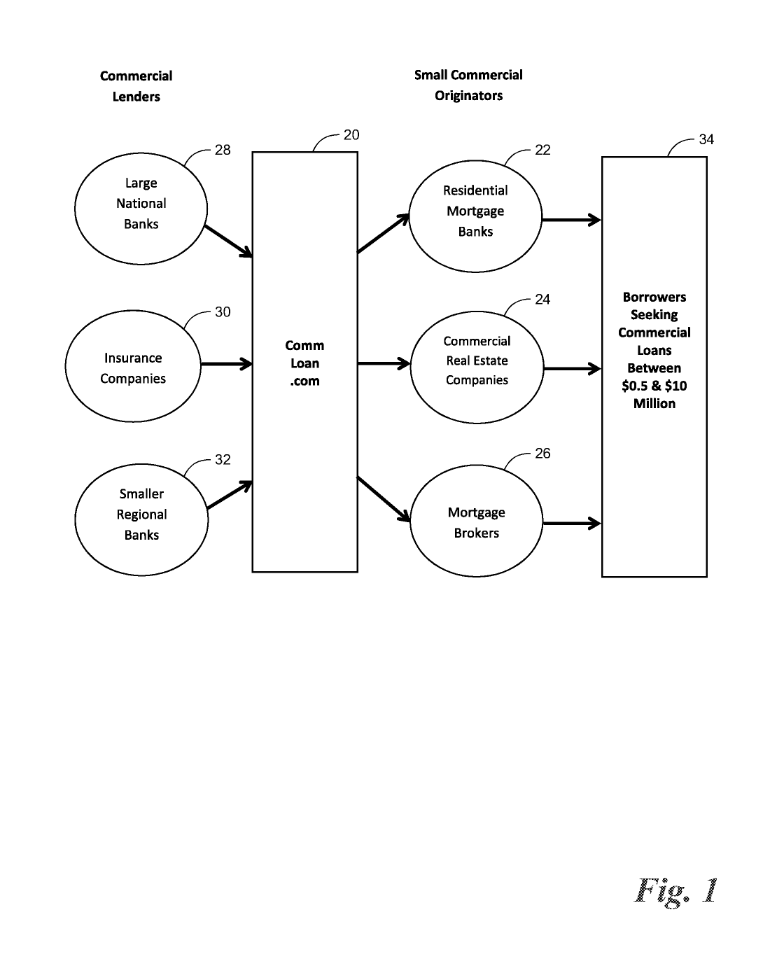

As shown in FIG. 1, the commercial loan platform, generally identified with the reference numeral 20, provides access to relatively small commercial loan originators, for example, residential mortgage banks 22, commercial real estate companies 24 contemplating providing financing and mortgage brokers 26 to literally hundreds of commercial lenders, such as large national banks 28, insurance companies 30 and smaller regional banks 32 that have previously dominated the commercial lending business. As such, borrower's 34 seeking commercial loans in the range of $0.5M to $10M, for example, can obtain their loans from residential mortgage banks 22, commercial real estate companies 24 and mortgage brokers 26.

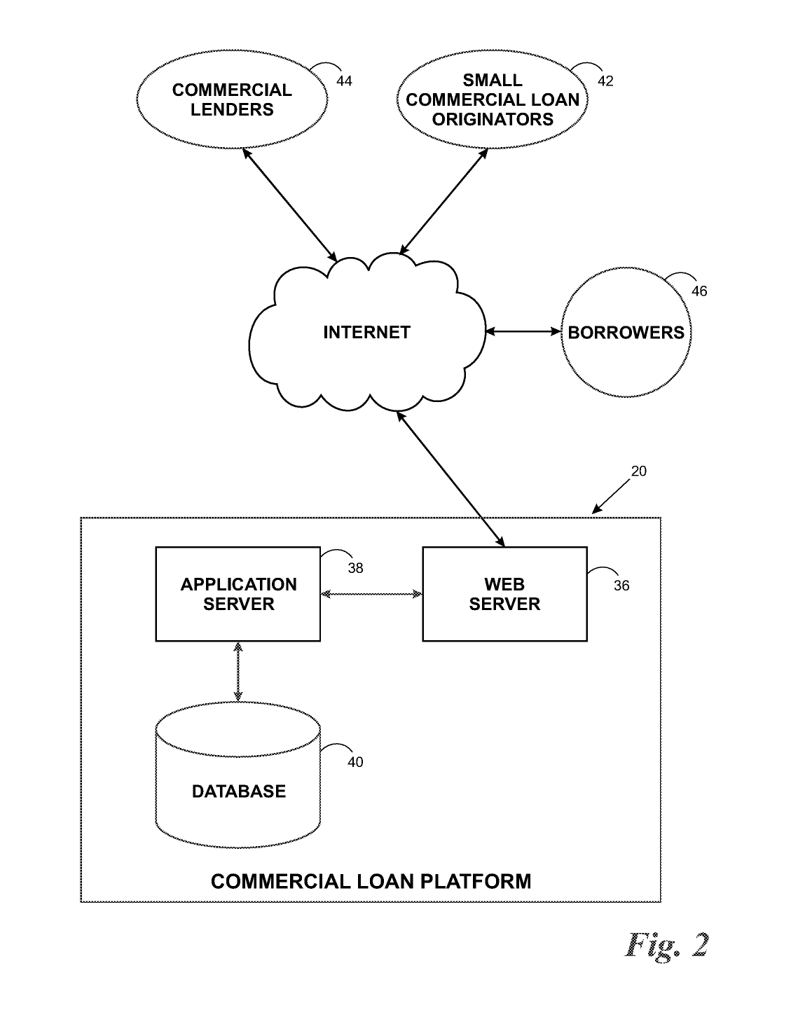

As shown in FIG. 2, the commercial loan platform 20 includes a web server 36 and an application server 38. Such an application server 38 includes a computer processing unit (CPU) and one or more memory storage devices. The application server 38 is used to run the commercial loan application processing, as discussed below. The application server 38 may include a database 40, which may be a local or remote database. The web server 36 which may be a separate computer or a software application, such as Apache or Netscape, running on the application server 38 that is used to create web pages. Each web server 36 normally has a domain name, for example, commloan.com. The various web pages contained on the web server 36 are identified by subdomains names. These web pages are thus accessible by URLs which include the form of subdomain@commloan.com.

One aspect of the present invention is the ability to optionally provide private label commercial loan processing to relatively small commercial originators 42 over the Internet. As such, each small commercial originator 42 is provided a URL in the form of subdomain@commloan.com. Each small commercial loan originator 42 is provided with a personalized website with a unique subdomain, such as mycommercialloancompany@commloan.com. The application server 38 handles all of the “back office” processing for commercial loan pre-qualification.

The prospective borrower 46 will have on-line access to an online loan application, description of loan programs and pricing available from the various commercial lenders 44, description of the loan process and all documentation required. On the same personalized website, the small commercial loan originator 42 will have access to literally hundreds of commercial lenders and loan programs and an automated underwriting system (AUS) and a matching engine to match the borrower 46 with the best possible loan.

In particular, the commercial loan platform 20 is connected to a multitude, for example, hundreds of commercial lenders 44. Thus, when a borrower 46 applies for a commercial loan through a small commercial originator 42, that borrower 46 will have access to a multitude of commercial lenders and thus a multitude of loans and programs in a manner that is transparent to the borrower 46 to enable the borrower 46 to get the most competitive loan that best fits their needs.

The commercial loan platform 20 also benefits the commercial lenders 44 and the small commercial originators 42. In particular, the commercial lenders 44 gain access to substantially more borrowers and increased loan transactions. By having access to hundreds of lending sources and marketing tools, smaller commercial mortgage originators will be able to service clients which previously would not have been cost effective. This commercial loan platform will be productive for building and maintaining client relationships, as well as adding to the bottom line through an additional revenue stream.

The commercial loan platform 20 also includes an Automated Underwriting System (AUS) and a matching engine. The AUS enables the small commercial loan originator 42 to run a loan scenario through the system to obtain a preliminary approval. In the residential mortgage market, these AUS systems have become the standard tool for approving loans. Fannie Mae provides the largest of these systems, called DU or Desktop Underwriting. No such systems are currently known to be available for commercial loans.

Another aspect of the invention relates to centralized processing of commercial loans. It is cost prohibitive for small commercial loan originators 42 to employ full-time experienced commercial loan processors, to process, for example, 2 to 3 loans per month. Residential lenders that wish to open a commercial division are not able to use their existing residential loan processors because the commercial loan packages are highly specialized. In order to keep costs down, a centralized pool of qualified commercial loan processors is provided for handling the required loan processing.

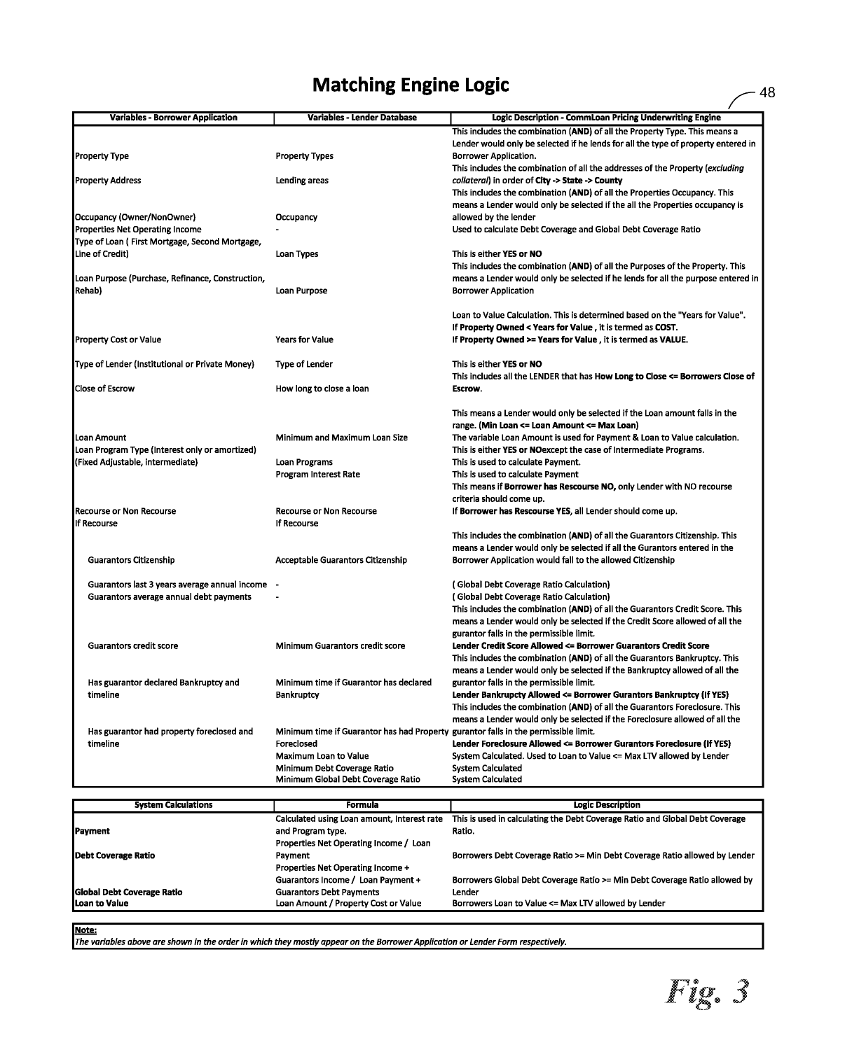

As discussed above, the automated underwriting system (AUS) is described in conjunction with FIG. 3. The AUS is implemented as a matching engine that runs on the application server 38 (FIG. 2). The matching engine is used to automatically match data from the commercial loan applications submitted by the borrowers 46 with the underwriting criteria from the commercial lenders, generally identified with the reference numeral 48 and stored on the database 40, for each of the commercial lenders 44. In particular, the AUS is used to match a lender's loan terms with the terms of the borrower's request. For example, certain commercial lenders 44 may restrict their loans to properties within predetermined geographical areas. Thus, these commercial lenders 44 are only matched with borrowers 46 requesting a commercial real estate loan for property within the predetermined geographical areas and also match the other criteria set forth by the commercial lender 44, for example, as illustrated in FIG. 3 as well as the underwriting metrics set forth below.

In addition to the underwriting criteria 48, commercial lenders 44 utilize additional underwriting metrics. These metrics include: debt coverage ratio; global debt coverage ratio and loan to value ratio and are automatically calculated by the application server 38 based upon data in the borrower's loan application.

The debt coverage ratio is the ratio of the Net Operating Income from the Property to the loan payment. Many known commercial lenders 44 are known to restrict the debt coverage ratio within a range of 1.1 to 1.4. For example, if the owner of a shopping mall receives $500,000 per month from tenants and expenses amount to $100,000 per month, a commercial lender will not provide a loan if the monthly payments exceeds ($500,000-$100,000)/1.1=$363,636 for a 1.1 debt coverage ratio. A debt coverage ratio <1 means there is not enough income from the property to make the monthly payments.

The global debt coverage ratio includes the loan guarantor's debt. The global debt coverage ratio of the (Net Operating Income from the Property+the Guarantor's income) to the (Loan Payment+the Guarantor's debt payments). The commercial lender 44 will require the global debt coverage ratio to be greater than or equal to the minimum debt coverage ratio allowed by the commercial lender. A global debt coverage ratio <1 means that the income from the property+the income from the guarantor are not sufficient to make the monthly payments and service the guarantor's other debt obligations.

The loan to value ratio the amount of the loan to the appraised value of the property if the property is owned for more than one year. Otherwise, the loan to value ratio is calculated using the cost. For example, if a borrower 46 wants to purchase a commercial office building for $6,000,000 that is worth $10,000,000, the loan to value ratio is $6,000,000/$10,000,000 or 60%. The loan to value ratio for commercial properties is normally in the range of 55% to 70%.

As mentioned above, two of the underwriting metrics; namely the debt coverage ratio and the global debt coverage ratio depend on the monthly loan payments. There are two types of loans; interest only loans and amortized loans.

In an interest only loan, pricing of the monthly payment is determined as by multiplying the loan amount by the annual interest rate to determine the annual payment. The annual payment is divided by 12 equal monthly payments.

Loan amortization is known in the art. Knowing the interest rate, amortization period and the loan amount enables the pricing of the monthly payments to be calculated. An amortized loan payment will have an equal payment over the amortization period. The payment will include both interest and principal as part of the payment. It works on the assumption that with an equal payment over the amortization period the loan will fully pay off. Interest is calculated on the outstanding principal balance each month. The early payments are mostly interest and a small amount of principal, and as the loan progresses the amount of the payment attributable to interest reduces and attributable to principal increases.

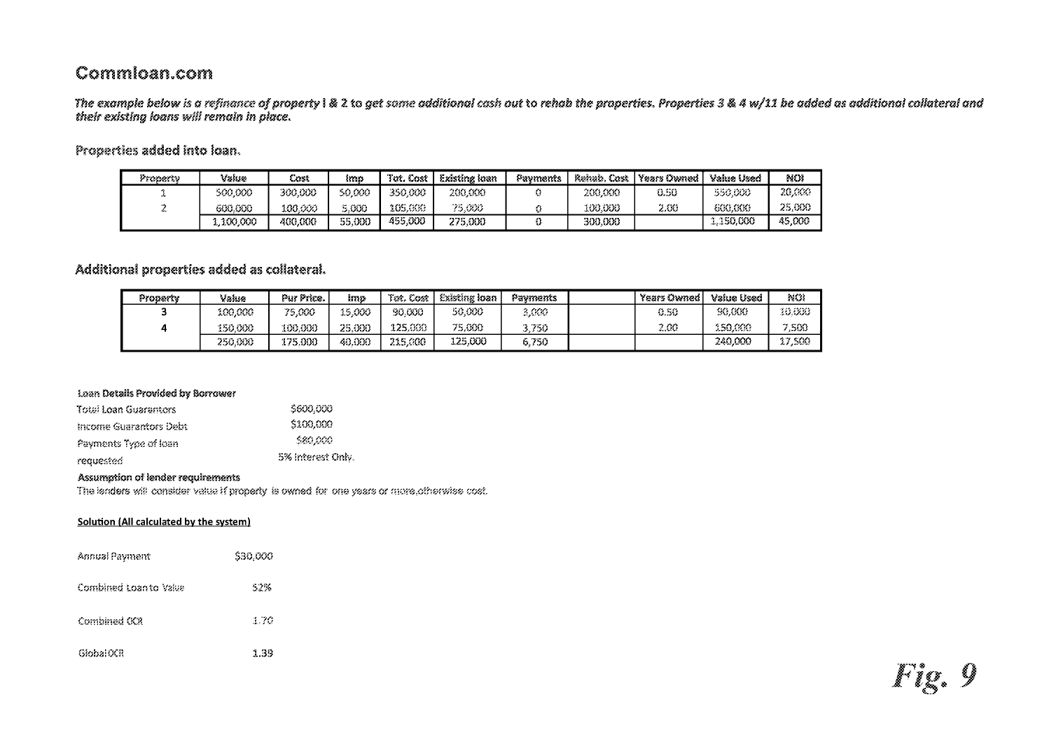

FIG. 9 illustrates an example of the underwriting metrics in which two properties 1 and 2 are refinanced for rehabilitation. An additional two properties 3 and 4 are put up as collateral with their existing loans maintained in place. Using the metrics described above and the data in FIG. 9, application server 38 (FIG. 2) automatically calculates the annual payment; the combined loan to value ratio, the debt coverage ratio and the global debt coverage ratio based upon data in the loan application. In this example, the annual payment is determined to be $30,000. The combined loan to value is determined to be 52%. The debt coverage ratio is determined to be 1.70 while the global debt coverage ratio is determined to be 1.39.

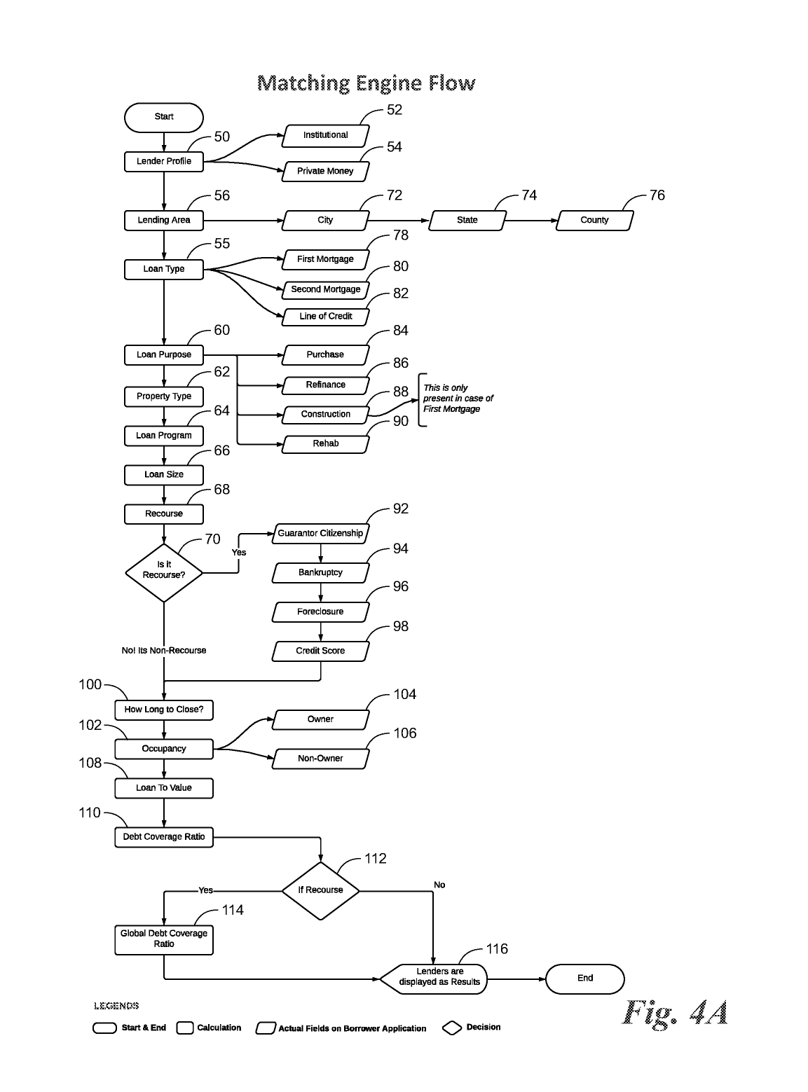

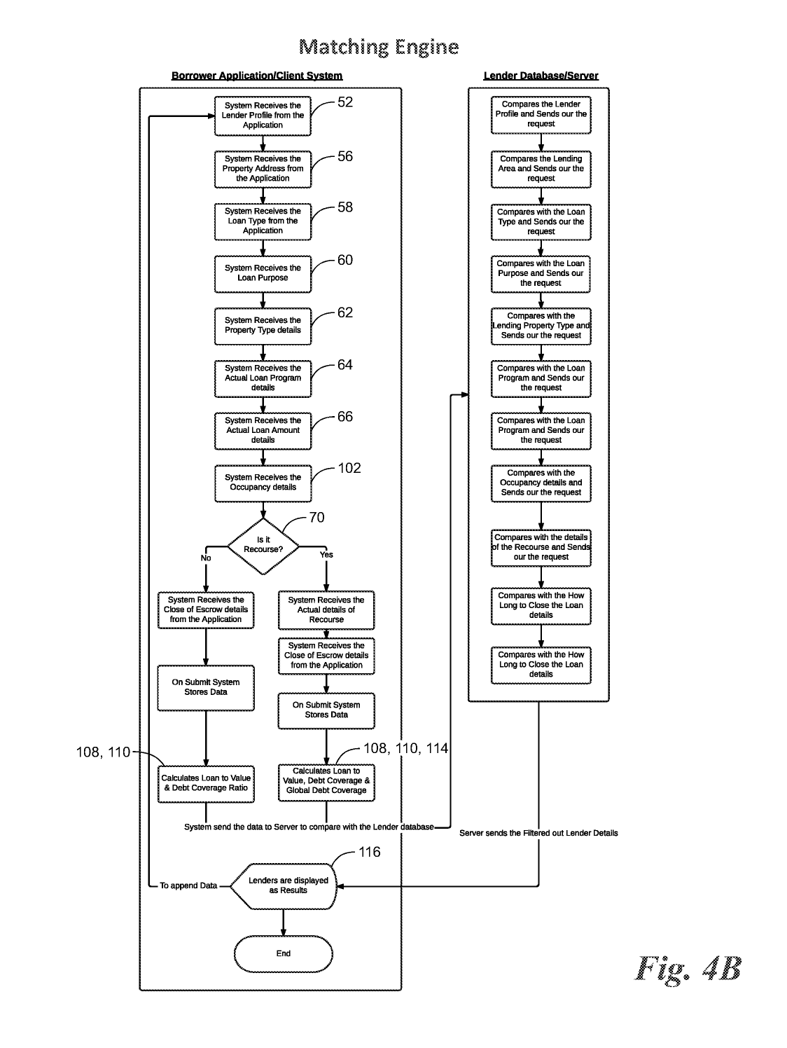

FIG. 3 illustrates the lender criteria while FIG. 4A and 4B illustrates an exemplary matching engine for matching borrowers with the lending criteria of the prospective commercial lenders. FIG. 4A is a logic diagram which illustrates exemplary embodiment of the matching engine in which each data point in the loan application is compared with the lender criteria in order to the borrower data with the lender criteria. As shown in FIG. 4A, each data point from the borrower's loan application is parsed and compared with the lender criteria before the next data point is parsed. In the alternate embodiment of the matching engine, illustrated in FIG. 4B, all data points of interest from the borrower's loan application are parsed before any comparisons with the lender criteria are done. In both embodiments, the matching engine parses selected data from a loan application and compares the data with lender criteria for the various lenders stored on the database 40 (FIG. 2). When all of the selected data from the loan application has been processed by the matching engine, the lenders that match all of the selected data from the loan application are displayed. These lenders will all be made available to the borrower.

Because of the similarity of FIGS. 4A and 4B, only FIG. 4A is described. Referring to FIG. 4A, initially in step 50, the matching engine parses the loan application for the lender profile desired by the borrower. Two exemplary categories are available to the borrower; institutional 52 and private money 54. Institutional 52 refers to banks and finance companies. Private money 54 refers to private equity firms. Depending on the selection by the borrower in the loan application, an initial group of potential lenders is determined to meet that criteria. When all of the selected data from the loan application has been processed, those lenders that match all of the criteria will be displayed and made available to the borrower.

As shown in FIG. 4, the matching engine processes the following criteria in the same manner as above in steps 56-66: lending area 56, loan type 58, loan purpose 60, property type 62, loan program 64 and loan size 66 by parsing data 72-90. As illustrated in FIG. 4 and described below, the steps are in no particular order. FIG. 4 simply illustrates an exemplary order of the steps.

In step 68, the matching engine checks if the loan is a recourse loan. Borrowers are personally liable for recourse loans. Such recourse loans allow the lender to collect the debt even after the collateral has been secured by the lender. With non-recourse loans, the borrower is not personally liable. With such loans, even though the lender can foreclose on the collateral, the lender cannot bring any personal actions against the borrower. Since the borrower is personally liable on a recourse loan, the matching engine searches the loan application for borrower data including the citizenship of the guarantor 92, whether the borrower was involved in a bankruptcy proceeding 94 or a foreclosure proceeding 96. In addition, the matching engine checks the borrower's credit score 98. Subsequently, the matching engine parses the loan application to check the time to close in step 100. If the loan is non-recourse, the matching engine proceeds from step 70 to step 100. The matching engine also checks for data on the occupancy for real estate transactions in step 102 to determine if the real estate will be owner occupied 104 or non-owner occupied 106.

As mentioned above, the application server 38 (FIG. 2) calculates the loan to value and the debt coverage ratio 110 based upon data in the loan application. If the loan is a recourse loan as determined in step 112, the application server 38 also calculates the global debt coverage ratio 114, as discussed above and proceeds to step 116 to display the lenders whose lending criteria matches up with data from the loan application. If the loan is a non-recourse loan as determined in step 114, the matching engine skips step 114 and proceeds to step 116 to display.

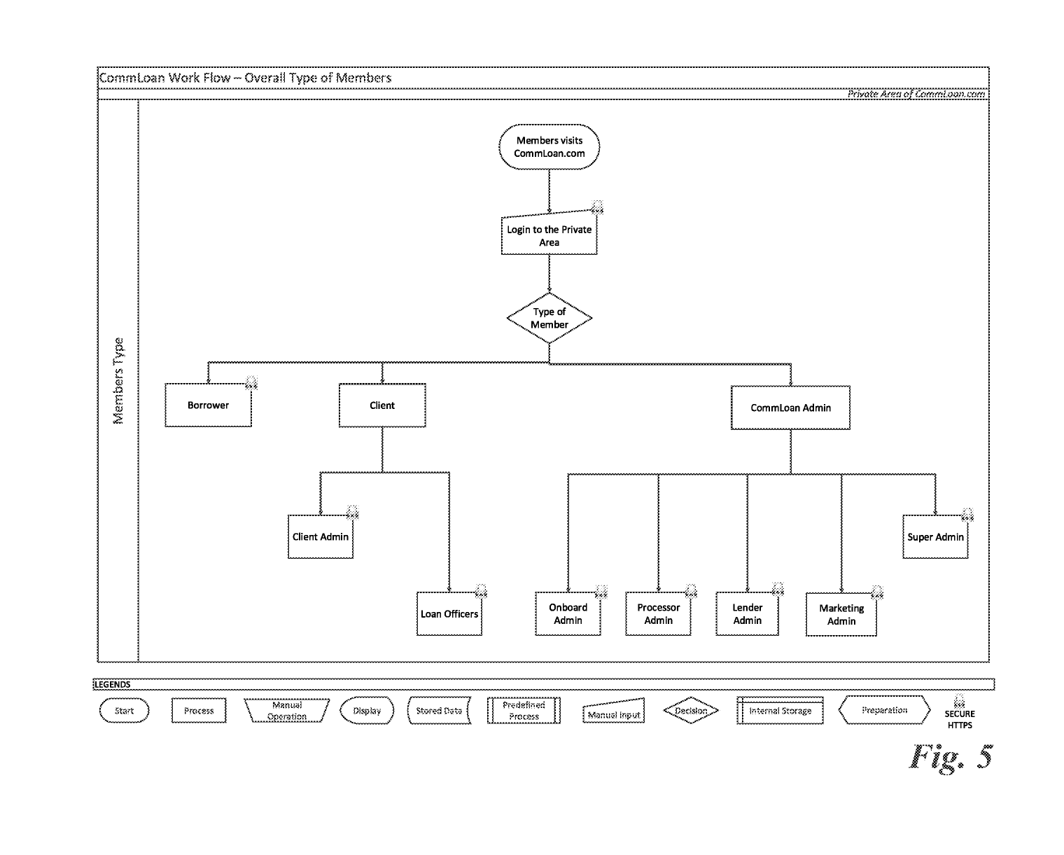

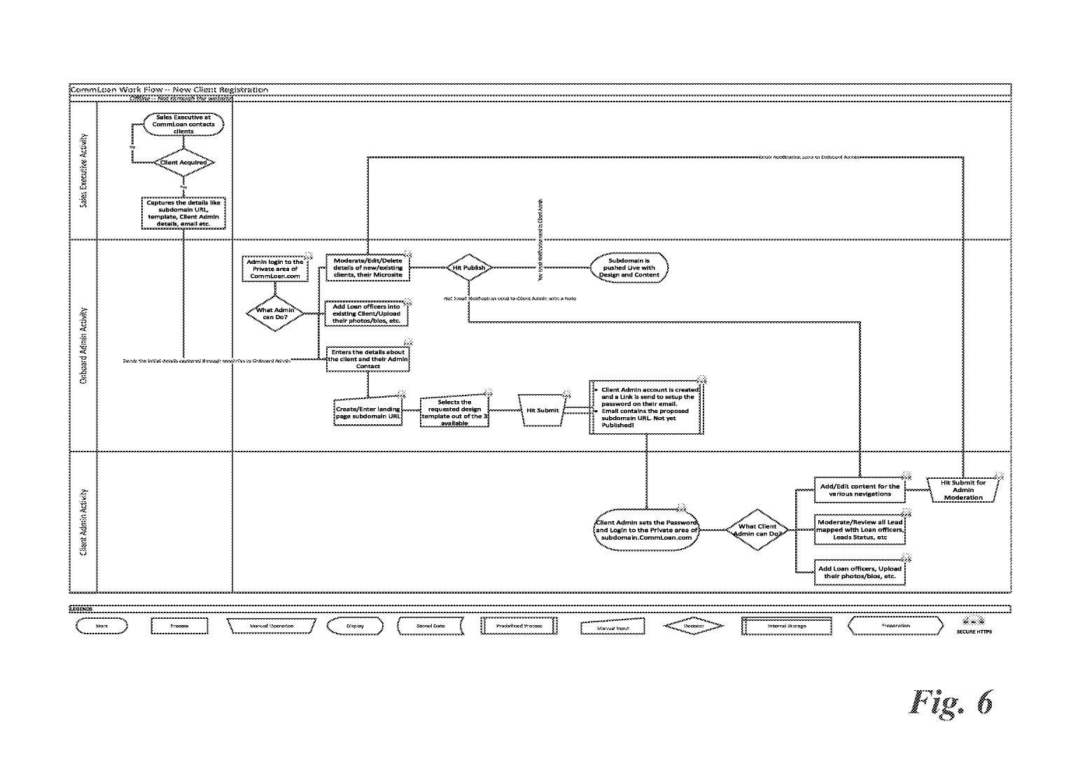

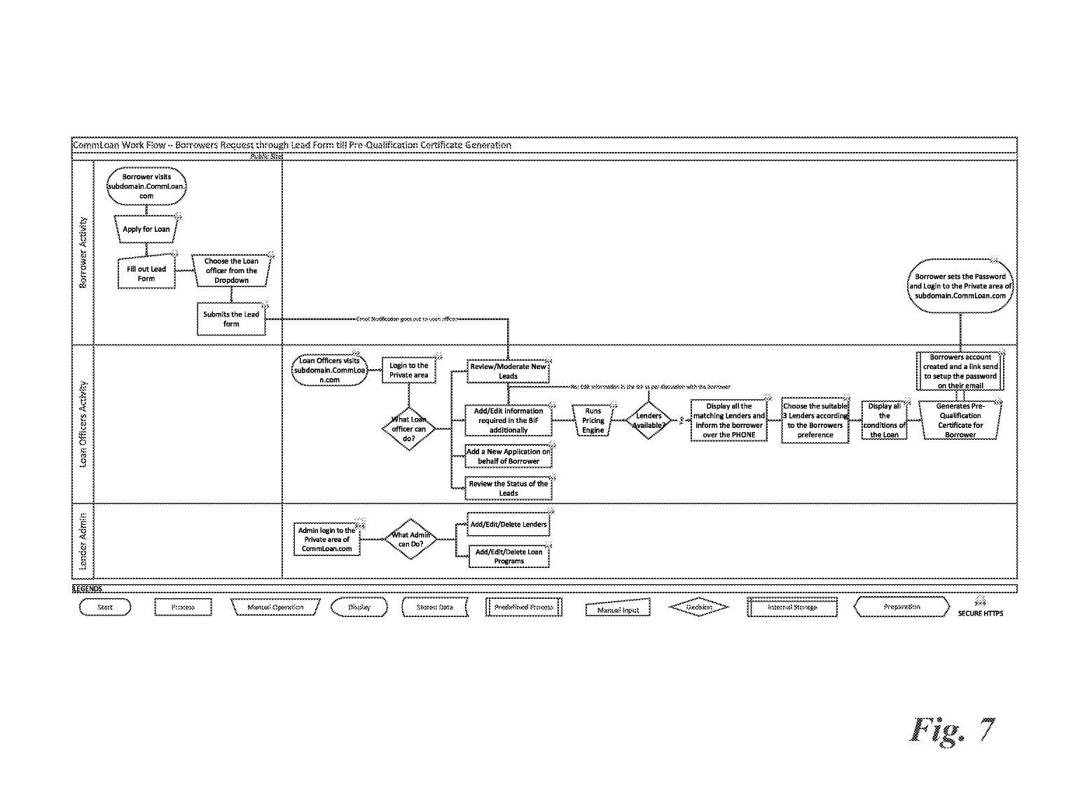

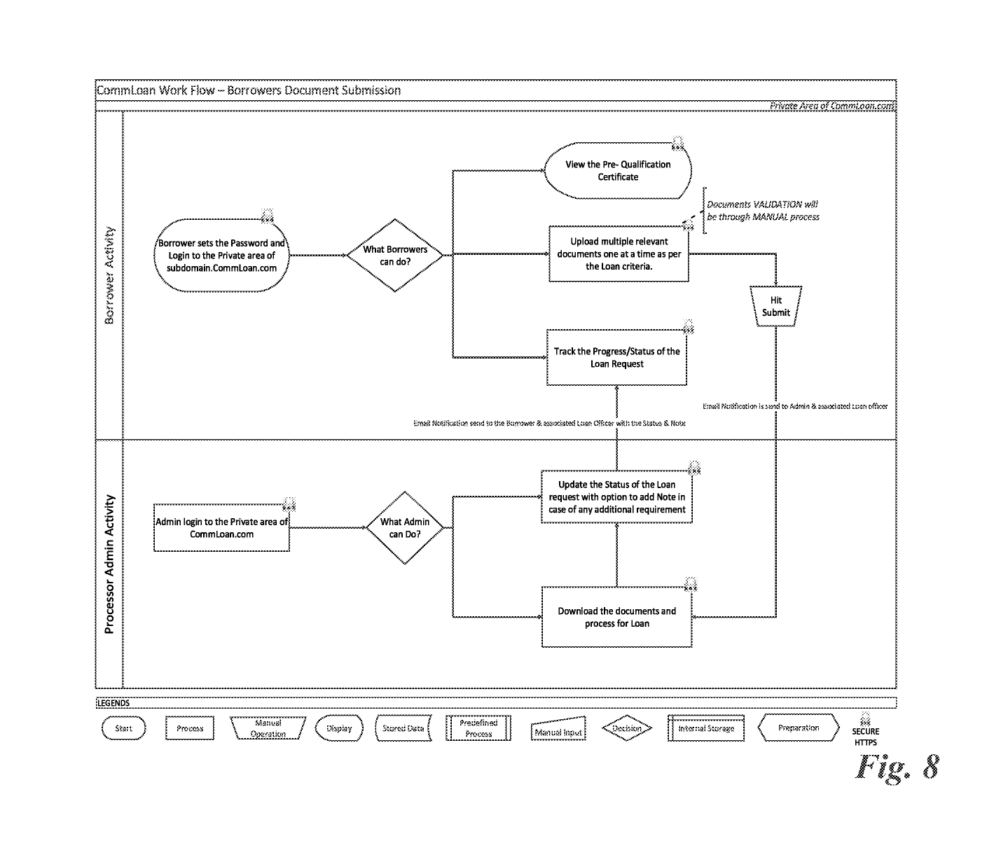

FIG. 5 illustrates is an exemplary diagram illustrating access to the commercial loan platform by various members. As used therein, the “client” refers to the small commercial loan originator. FIGS. 6-8 illustrate exemplary work flow diagrams for the system. In particular, FIG. 6 is an exemplary logic diagram illustrating new client registration. FIG. 7 is an exemplary logic diagram illustrating a borrower's access to the commercial loan platform. FIG. 8 is an exemplary logic diagram illustrating the borrower's submission process.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A computer system for forming a commercial loan platform comprising:
an application server for calculating various commercial loan metrics;
a database for storing lending criteria for a plurality of commercial loan lenders;
a matching engine for matching the lending criteria for said plurality of commercial loan lenders with borrower data from a loan application to identify the borrower data that matches criteria of the commercial loan lenders and satisfies the commercial loan metrics; and
a central processing system for processing commercial loans for commercial loan lenders selected by said borrowers.

2. A computer system for providing a web based loan platform for commercial loans for providing indirect access to borrowers to multiple commercial loan lenders to enable identify one or more commercial lenders that match one or more data points on the borrower's loan application, the computer system comprising:
a web server for hosting a plurality of loan originators on a private label basis, said web server configured to provide access to said borrowers to one or more private label loan originators to enable said borrowers to apply for commercial loans from said private label commercial loan originators on-line, said web server further configured to provide access to said private label commercial loan originators to a plurality of commercial loan lenders;
an application server in communication with said web server for parsing various data points in a borrower's loan application, said application engine including a matching engine for matching said data points on the borrower's loan application with the underwriting criteria of one or more commercial loan lenders whose criteria matches the borrower's data points;
a database for storing the underwriting criteria of one or more commercial lenders;
a display for displaying all potential commercial loan lenders whose criteria matches said one or more data points of said borrower's loan application; and
a central processing system for processing a commercial loan for commercial loan lenders selected by said borrower.

3. The computer system as recited in claim 2, wherein said application server is configured to calculate one or more underwriting metrics from data in the borrower's loan application and to compare the one or more underwriting metrics with one or more metrics established by the commercial loan lender used to decide whether to make a loan to the borrower.

4. The computer system as recited in claim 3, wherein said underwriting metrics include the borrower's debt coverage ratio.

5. The computer system as recited in claim 3, wherein said underwriting metrics include the borrower's global debt coverage ratio.

6. The computer system as recited in claim 3, wherein said underwriting metrics include loan to value ratio.

7. The computer system as recited in claim 2, wherein said underwriting criteria includes lending area.

8. The computer system as recited in claim 2, wherein said underwriting criteria includes loan type.

9. The computer system as recited in claim 2, wherein said underwriting criteria includes loan purpose.

10. The computer system as recited in claim 2, wherein said underwriting criteria includes property type.

11. The computer system as recited in claim 2, wherein said underwriting criteria includes the loan program.

12. The computer system as recited in claim 2, wherein said underwriting criteria includes the loan size.

13. The computer system as recited in claim 2, wherein said underwriting criteria is based upon whether the loan is recourse.

14. The computer system as recited in claim 2, wherein said underwriting criteria includes time to close.

15. The computer system as recited in claim 2, wherein said underwriting criteria includes occupancy.

16. A method for providing borrowers access to a plurality commercial lenders, the method comprising:
storing borrowers commercial loan application;
storing underwriting criteria for a plurality of commercial loan lenders;
parsing borrowers commercial loan applications for various data;
comparing said borrower data with said underwriting criteria to match a borrower with one or more commercial lenders; and
closing the commercial loan between said borrower and a selected commercial lender.

17. The method as recited in claim 16, further including the step of storing underwriting metrics and comparing said borrower data with said underwriting metrics to match a borrower with one or more commercial lenders.

18. A computer system for providing a web based loan platform for commercial loans for providing direct access to borrowers to a plurality of commercial loan lenders to enable a commercial lender to be selected that matches one or more data points on the borrower's loan application data, the computer system comprising:
web server configured to enable borrowers to file and store a commercial loan application data on-line and provide direct access to a plurality of commercial loan lenders;
an application server in communication with said web server for parsing various data points in said borrower's loan application data, said application engine including a matching engine for matching said data points on the borrower's loan application data with the underwriting criteria of one or more commercial loan lenders whose criteria matches the borrower's data points;
a database for storing the underwriting criteria of one or more commercial lenders;
a display for displaying all potential commercial loan lenders whose criteria matches said one or more data points of said borrower's loan application; and
a central processing system for processing a commercial loan for commercial loan lenders selected by said borrower.

19. The computer system as recited in claim 18, wherein said application server is configured to calculate one or more underwriting metrics from data in the borrower's loan application and to compare the one or more underwriting metrics with one or more metrics established by the commercial loan lender used to decide whether to make a loan to the borrower.

20. The computer system as recited in claim 19, wherein said underwriting metrics include the borrower's debt coverage ratio.

21. The computer system as recited in claim 19, wherein said underwriting metrics include the borrower's global debt coverage ratio.

22. The computer system as recited in claim 19, wherein said underwriting metrics include loan to value ratio.

23. The computer system as recited in claim 18, wherein said underwriting criteria includes lending area.

24. The computer system as recited in claim 18, wherein said underwriting criteria includes loan type.

25. The computer system as recited in claim 18, wherein said underwriting criteria includes loan purpose.

26. The computer system as recited in claim 18, wherein said underwriting criteria includes property type.

27. The computer system as recited in claim 18, wherein said underwriting criteria includes the loan program.

28. The computer system as recited in claim 18, wherein said underwriting criteria includes the loan size.

29. The computer system as recited in claim 18, wherein said underwriting criteria is based upon whether the loan is recourse.

30. The computer system as recited in claim 18, wherein said underwriting criteria includes time to close.

31. The computer system as recited in claim 18, wherein said underwriting criteria includes occupancy.
